(19) United States
(12) Patent Application Publication
(10) Pub. No.: US 2012/0058218 A1
(43) Pub. Date: Mar. 8, 2012

(54) FROZEN CONFECTIONERY HOLDER

(76) Inventors: Daniel R. Blondeau, Cincinnati, OH (US); Paul J. VanRisseghem, Cincinnati, OH (US)

(21) Appl. No.: 13/198,189

(22) Filed: Aug. 4, 2011

Related U.S. Application Data
(60) Provisional application No. 61/371,060, filed on Aug. 5, 2010.

(51) Int. Cl. A23G 9/50; B65D 6/02; B65D 25/28; A23K 1/18

(52) U.S. Cl. 426/2; 426/135; 220/669; 220/758

(57) ABSTRACT

A holder for confectioneries and particularly frozen confectioneries. The holder includes a receptacle having a shape that is complementary to the shape of the confectionery and being configured to allow a major portion of the confectionery to be exposed when the confectionery is received in and supported by the receptacle, and a handle coupled to a bottom portion of the receptacle to allow the holder to be hand held. The holder is particularly useful for holding frozen confectioneries such as ice cream bars, ice cream sandwiches, etc. that are not provided with handles.

### RELATED APPLICATION

This application is based on U.S. Provisional Application Ser. No. 61/371,060, filed Aug. 5, 2010, to which priority is claimed under 35 U.S.C. §120 and of which the entire disclosure of which is hereby expressly incorporated by reference.

### BACKGROUND

The present invention relates generally to frozen confectioneries and more particularly relates to a device for holding frozen confectioneries and more particularly to a device for holding frozen confectioneries when they are being consumed.

There are frozen confectioneries such as chocolate coated ice bars and ice cream sandwiches that are not provided with handles. One eating such frozen confectioneries has to carefully open the wrapper without removing the wrapper, and hold the frozen confectionery by holding the same with a portion of the wrapper. This is difficult for an adult and extremely difficult for a young child who is trying not to get his or her fingers contaminated with the chocolate coating or pastry/cake on the outside of the ice cream center. The present invention provide a convenient holder for such frozen confectioneries and other confectioneries.

U.S. Pat. No. 2,632,708 to Sueskind discloses an eatable cup-shaped member that is designed to receive an ice cream bar or frozen pop that is supported on a wooden stick or handle. The eatable cup-shaped member is made from a pastry or other suitable material and includes a slit in the bottom through which the wooden stick or handle of an ice cream bar or frozen pop is inserted. The cup-shaped member catches the drippings from the ice cream bars or frozen pops.

U.S. Pat. No. 3,459,296 to Berg discloses a receptacle and support for a frozen confection which includes a handle portion and a body portion. The handle portion is received in the body portion and can include a stem that is inserted into the frozen confection or a handle with a plate and a stem.

U.S. Pat. No. 1,835,719 to Parr discloses an eatable ice cream holder which comprises a receptacle having a bore in the base of the receptacle for receiving a round stick.

U.S. Pat. Nos. D549,628 to Chen, 6,941,982 to Swan et al., D391,036 to Sotile, 5,224,646 to Biancosino, and 4,226,355 to Helfrich, Jr. disclose frozen confectionery holders for ice cream cones.

U.S. Pat. No. 6,571,979 to Schmarr discloses a holder for frozen confectioneries that are supported on wooden sticks.

U.S. Pat. Nos. D442,764 to Jimenes and D382,085 to Sotile disclose miscellaneous holders for frozen confectioneries.

The prior art admits the necessity of being able to eat frozen confectioneries without holding the frozen confectioneries directly in one's hands. This is because the frozen confectionaries will melt when held directly by one's hands. For all confectioneries this melting can be a problem in that it causes one's hands to become contaminated and sticky. In the case of chocolate covered or frosted confectioneries or other types of coated confectioneries, this melting can create quite a mess, especially when children attempt to eat such confectioneries while holding them directly in their hands.

The present invention provides a holder for frozen confectionaries that can be used to eat frozen confectioneries without having to directly hold the confectioneries in one's hands.

### BRIEF SUMMARY

According to various features, characteristics and embodiments of the present invention which will become apparent as the description thereof proceeds, the present invention provides a holder for confectioneries that have a geometric shape which holder includes:

a receptacle that is configured to receive a confectionery having a geometric shape, the receptacle having a shape that is complementary to the geometric shape of the confectionery and being configured to allow a major portion of the confectionery to be exposed when the confectionery is received in and supported by the receptacle; and

a handle coupled to a bottom portion of the receptacle to allow the holder to be hand held.

The present invention further provides the combination of a holder for confectioneries with a confectionery supported in the receptacle of the holder.

The present invention also provides for a method of eating a confectionery that has a geometric shape and which does not include a handle, the method comprising:

providing:
a confectionery having a geometric shape;
a receptacle having a shape that is complementary to the geometric shape of the confectionery and being configured to allow a major portion of the confectionery to be exposed when the confectionery is received in and supported by the receptacle; and
a handle coupled to a bottom portion of the receptacle to allow the holder to be hand held;

placing a portion of the confectionery into the receptacle so that a major portion of the confectionery is exposed; and

eating at least the exposed portion of the confectionery.

### BRIEF DESCRIPTION OF THE DRAWINGS

The present invention will be described with reference to the attached drawings which are given as non-limiting examples only, in which:

FIG. 1 is a perspective view of a frozen confectionery holder according to one embodiment of the present invention.

FIG. 2 is a front planar view of the frozen confectionery holder of FIG. 1.

FIG. 3 is top view of the frozen confectionery holder of FIG. 1.

FIG. 4 is a side view of the frozen confectionery holder of FIG. 1.

FIG. 5 is a front planar view of the frozen confectionery holder according to another embodiment of the present invention.

FIG. 6 is a top view of the frozen confectionery holder of FIG. 5.

FIG. 7 is a side view of the frozen confectionery holder of FIG. 5.

FIG. 8 is a front planar view of the frozen confectionery holder according to another embodiment of the present invention.

FIG. 9 is a side view of the frozen confectionery holder of FIG. 8.

FIG. 10 is a cross-sectional view of a portion of a front wall of a receptacle looking toward the bottom according to one embodiment of the present invention.

FIGS. 11-13 are perspective views of frozen confectionary holders according to further embodiments of the present invention.

### DETAILED DESCRIPTION OF THE DRAWINGS AND THE PRESENTLY PREFERRED EMBODIMENTS

The present invention provides a device for holding frozen confectioneries and more particularly to a device for holding frozen confectioneries when they are being consumed. The device of the present invention comprises a holder that includes a receptacle at an upper end (when oriented in use) and a handle that extends downward (when oriented in use) from the receptacle. The receptacle is configured and sized to receive a frozen confectionery therein and configured and sized to allow a major portion of the frozen confectionery to be exposed and assessable for eating the same. In a preferred embodiment at a minimum about half of the frozen confectionery is exposed when inserted in the receptacle and more preferable more than half to two-thirds or three-quarters or more of the frozen confectionery is exposed when inserted in the receptacle.

The device of the present invention is designed and configured to receive and hold frozen confectioneries that are not provided with holders or handles such as wooden or plastic sticks or stems that are inserted or molded into the frozen confectioneries. In this regard, the receptacle of the present invention is provided with a solid, imperforated bottom that does not include a slit through which a stick or stem can be inserted or passed there through.

The device of the present invention is configured and designed to receive and hold frozen confectioneries that are square, rectangular, triangular, circular, or that have any other geometric or non-geometric shape. In this regard, the receptacle of the present invention can have an overall partially square, rectangular, triangular or circular shape or can have the partial shape of any other geometric or non-geometric shape. By being “partially” square, rectangular, triangular or circular shaped or having the “partial” shape of any other geometric or non-geometric shape, the intent is for the receptacle to be sufficiently complementarily shaped to the frozen confectionery to receive and hold the confectionery while allowing at least a major portion of the confectionery to be accessible and exposed for eating the confectionery.

Frozen confectioneries for which the device of the present invention is designed to receive and hold include chocolate (or other flavor) covered ice cream bars that can be square, rectangular, triangular, circular, or that have any other geometric or non-geometric shapes, ice cream sandwiches or the like that have a center layer of ice cream and outer opposed layers of cake, pastry or the like. In addition, the device of the present invention can receive and hold non-coated ice cream bars, frozen fruit or fruit juice or frozen yoghurt or pop or other naturally or artificial sweetened compositions/articles that are square, rectangular, triangular, circular, or that have any other geometric or non-geometric shapes.

While the holder of the present invention was initially designed and developed to hold frozen confectioneries, it is within the scope of the present invention to use the holder of the present invention to hold brownies, cakes, pastries and other non-frozen confectioneries as well as other types of foods. Thus reference herein to a “frozen confectionery holder” is not intended to limit the present invention to only holding frozen confectioneries.

The handle that extends downward (when oriented in use) from the receptacle, is sized and configured to be easily held in a user's hand. According to one embodiment of the present invention the receptacle and handle are formed, e.g. molded, as a single integral structure. According to an alternative embodiment of the present invention the receptacle and handle can be formed as separate structural elements that are coupled together in any suitable manner, including mechanical coupling or chemical coupling. Examples of mechanically coupling the handle to the receptacle include the use of cooperating snap-fit or press-fit or interlocking/coupling cooperating structures that are provided on the handle and receptacle, or the use of auxiliary mechanical elements, such as screws, pins, rivets, etc. Examples of chemically coupling the handle to the receptacle include glues, adhesives, epoxies, etc. Further the handle and receptacle can be coupled together by welding these elements together.

The handle is sized and configured to be easily held in a user's hand and preferably does not include any sharp or pointed surfaces or structures. The handle can have almost any length in the range of from about 1 to about 5 inches and more preferably from about 2 to about 4 inches. The handle is preferably straight and can have any suitable cross-sectional shape, including a circular, rectangular, square, oval cross-sectional shape or any geometric or non-geometric cross-sectional shape. According to one embodiment the handle is straight and has cross-sectional shape that has an i-beam shape or the shape of an “H” or an “X” or “+.” According to another embodiment of the present invention the handle can be formed with a plurality of ribs or webs as discussed below. The cross-sectional shape of the handle can be uniform or non-uniform along the length of the handle.

In general, the handle has a width that is smaller than the width of the receptacle; however, the handle could have a width that is equal or substantially equal to the width of the receptacle.

The confectionery holder of the present invention is preferable made from moldable food-grade plastic materials that can be washed for reuse. It is also possible to make the confectionery holder from a combination of food-grade materials such as water-resistant reinforced paper or cardboard or a composite or laminated material that may or nor be biodegradable with a plastic, paper, or wooden handle that provides a single use, disposable holder.

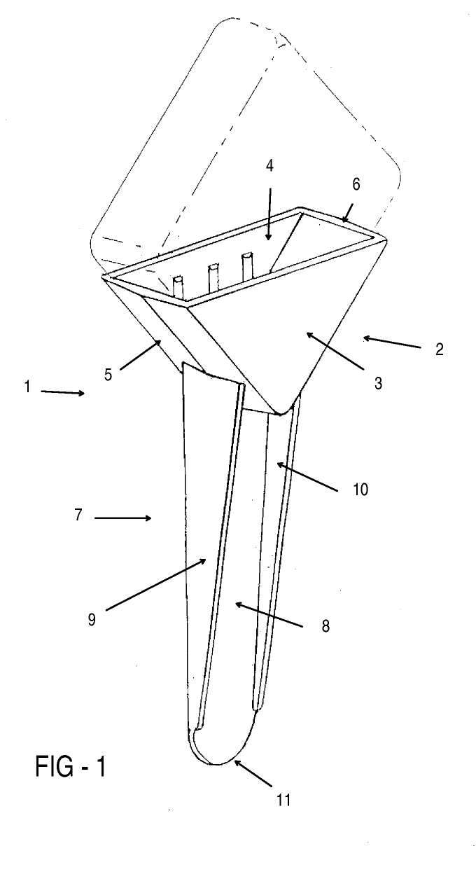

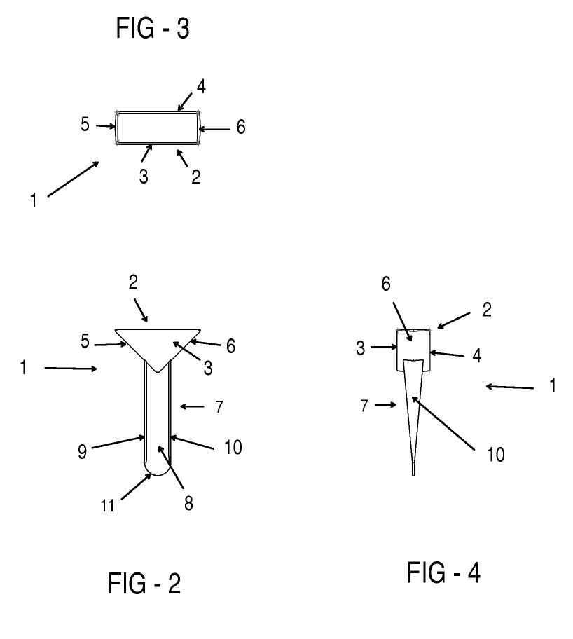

FIG. 1 is a perspective view of a frozen confectionery holder according to one embodiment of the present invention. FIG. 2 is a front planar view of the frozen confectionery holder of FIG. 1. FIG. 3 is top view of the frozen confectionery holder of FIG. 1. FIG. 4 is a side view of the frozen confectionery holder of FIG. 1.

The frozen confectionery holder 1 of FIGS. 1-4 has a triangular or corner-shaped receptacle 2 that is defined by opposed triangular-shaped front and back panels 3 and 4 and rectangular-shaped opposed side panels 5 and 6 which join together an the bottom of the receptacle 2. The receptacle 2 of this embodiment is designed, configured and sized to hold a frozen confectionery that has a generally square or rectangular shape and a thickness that is slightly less than the inner thickness of the receptacle measured between the front and back panels 3 and 4. In particular, the receptacle 2 is configured to hold such a frozen confectionery by one of the corners of the frozen confectionery and is sized to receive and support the frozen confectionery by a corner so that a major portion of the frozen confectionery to be exposed and assessable for eating the same, as discussed above, i.e. so that at a minimum about half of the frozen confectionery is exposed when inserted in the receptacle and more preferable half to two-thirds or three-quarters or more of the frozen confectionery is exposed when inserted in the receptacle. FIG. 1 depicts a frozen confectionery in broken lines.

The frozen confectionery holder 1 includes a handle 7 that, in the embodiment shown, includes a central elongate portion 8 and opposed side panels 9 and 10. The central portion 8 of the handle 7 has a generally elongate rectangular shape with a curved bottom portion 11. The top of the central portion 8 of the handle 7 has a V-shaped top that is configured to fit against the bottom corner of the receptacle 2 wherein the opposed side panels 5 and 6 which join together. The opposed side panels 9 and 10 reinforce the central portion 8 and are tapered so as to be wider at their tops and taper to points that terminate just above the curved bottom portion 11 of the central portion 8 of the handle 7.

The handle has a cross-sectional shape that forms a wide “H” with the central portion 8 forming the center of the “H” and the opposed side panels 9 and 10 forming the sides of the “H.”

As a non-limiting example of dimensions for using a frozen confectionery holder shown in FIGS. 1-4 to receive an hold a Klondike Bar, the thickness of the receptacle measured between the front and back panels 3 and 4 can be about 1.1 to about 1.3 inches and the width at the top of the receptacle between the top edges of the opposed side panels 5 and 6 can be about 3.1 to about 3.3 inches.

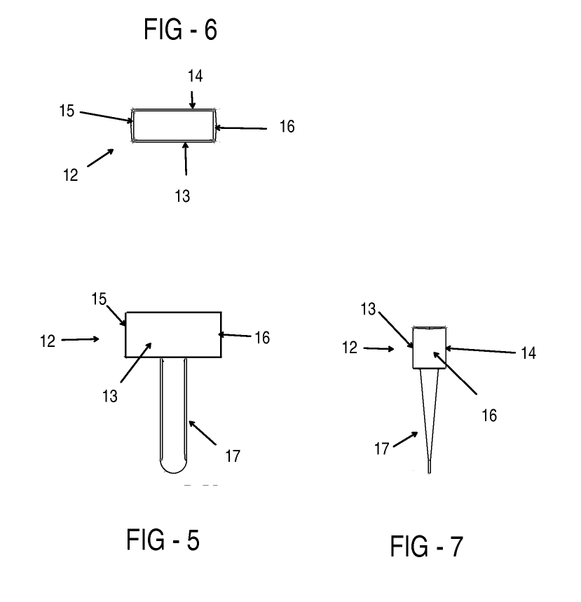

FIG. 5 is a front planar view of the frozen confectionery holder according to another embodiment of the present invention. FIG. 6 is a top view of the frozen confectionery holder of FIG. 5. FIG. 7 is a side view of the frozen confectionery holder of FIG. 5. The frozen confectionery holder of FIGS. 5-7 has a rectangular shaped receptacle 12 having rectangular front and back panels 13 and 14 and opposed side panels 15 and 16. The receptacle 12 of this embodiment is designed, configured and sized to hold a frozen confectionery that has a generally square or rectangular shape, by a side edge that has a length that is slightly less than the inner width of the receptacle measured between the opposed side panels 15 and 16 and a thickness that is slightly less than the inner thickness of the receptacle measured between the front and back panels 13 and 14. In particular, the receptacle 12 is configured to hold such a frozen confectionery by one side of the frozen confectionery and is sized to receive and support the frozen confectionery so that a major portion of the frozen confectionery to be exposed and assessable for eating the same, as discussed above, i.e. so that at a minimum about half of the frozen confectionery is exposed when inserted in the receptacle and more preferable half to two-thirds or three-quarters or more of the frozen confectionery is exposed when inserted in the receptacle.

The frozen confectionery holder includes a handle 17 that is the same as the handle 7 described in reference to FIGS. 1-4.

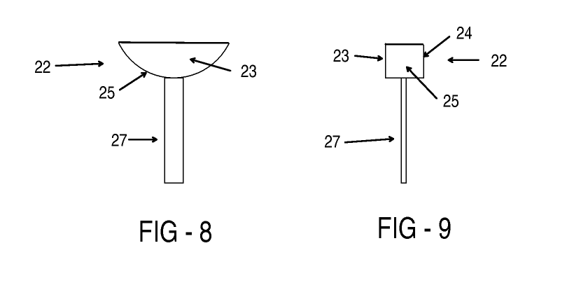

FIG. 8 is a front planar view of the frozen confectionery holder according to another embodiment of the present invention. FIG. 9 is a side view of the frozen confectionery holder of FIG. 8. The frozen confectionery holder of FIGS. 8 and 9 has a semi-circular shaped receptacle 22 having semi-circular shaped front and back panels 23 and 24 and a curved bottom panel 25. The receptacle 22 of this embodiment is designed, configured and sized to hold a frozen confectionery that has a generally circular shape and a thickness that is slightly less than the inner thickness of the receptacle measured between the front and back panels 23 and 24. In particular, the receptacle 22 is configured to hold such a frozen confectionery by one side of the frozen confectionery and is sized to receive and support the frozen confectionery so that a major portion of the frozen confectionery to be exposed and assessable for eating the same, as discussed above, i.e. so that at a minimum about half of the frozen confectionery is exposed when inserted in the receptacle and more preferable half to two-thirds or three-quarters or more of the frozen confectionery is exposed when inserted in the receptacle.

The frozen confectionery holder includes a handle 27 that is an elongated structure having a width as shown in FIG. 8 and a thickness that is shown in FIG. 9. In the embodiment shown the handle 27 has a width that is greater than the thickness so that the handle 27 has a rectangular cross-sectional shape. In alternative embodiments the handle can have a square or circular cross-sectional shape or any geometric or non-geometric cross-sectional shape and can be solid and or hollow.

In each embodiment the bottom of the receptacle is preferable a solid, imperforated bottom that does not include a slit or slot through which a stick or stem can be inserted or passed there through. Such a bottom will prevent frozen confectioneries from dropping onto the hands of people holding the handle and eating the frozen confectioneries. By having a closed bottom, as opposed to having slits or slots and depending hollow handles into which a stick or stem of a frozen confectionery can be received, the receptacles of the present invention can be easily washed for reuse. In this regard, the frozen confectionery holder of the present invention can be made from food grade plastic materials, including materials that can be cleaned in a dishwasher.

It is further noted that the bottom of the receptacle does not require or include an upstanding structure upon which the frozen confectionery can be impaled to support the frozen confectionery, in this regard, the front, back and side walls of the receptacle are relied upon to support the frozen confectionery. In order to enable maximum exposure of a confectionary held in the receptacles, the heights of the any one or all of the side, front and back panel have be minimized so as to support a confectionary while allowing maximum exposure of a confectionary. Such a configuration can result in some or all the side, front and back panels having different heights and shapes.

The bottoms of the receptacles to which the handles are attached are further stationary or fixed with respect to the front, back and side walls.

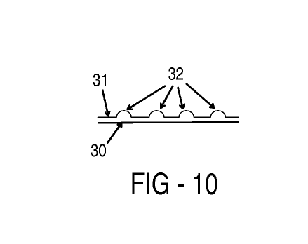

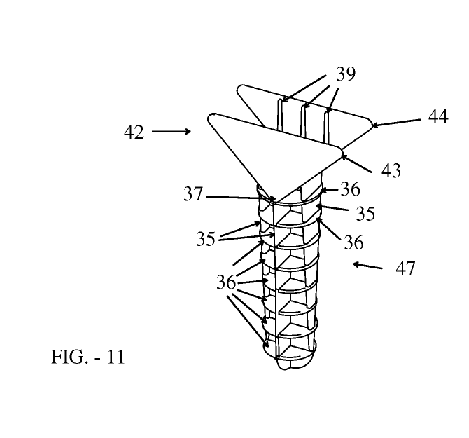

While the inner dimensions of the receptacles should be appropriately sized to receive and hold frozen confectioneries, it is understood that there are some variances in the dimensions, and particularly the thickness of frozen confectioneries. For example, a chocolate covered Klondike ice cream bar has a thickness that is slightly less than the thickness of a Klondike ice cream sandwich. In order to make the receptacles of the present invention compatible for frozen confectioneries that have small variances in thickness, the inner walls of the receptacle can include small ribs or ridges that protrude towards the inside of the receptacles. FIG. 10 is a cross-sectional view of a portion of a front wall of a receptacle looking toward the bottom according to one embodiment of the present invention. In FIG. 10 the outside surface of the wall 30 can be relatively smooth or of any desired shape or texture and the inside surface of the wall 31 can be provided with several small ribs or ridges that protrude towards the inside of the receptacles. These small ribs or ridges are aligned to be vertical and can extend from near the tops of the front and back walls to at or near the bottom of the receptacles, and can increase in size from the top to the bottom if desired. In other embodiments, a series of discrete ribs or ridges such as dimples can be provided on the inner walls of the receptacles.

FIGS. 11-13 are perspective views of frozen confectionary holders according to further embodiments of the present invention. In the embodiments depicted in FIGS. 11-13 the handles 47 have a general cylindrical or tapered cylindrical shape that is formed by a plurality of vertically oriented ribs or webs 35 and a plurality of horizontally oriented ribs or webs 36. As can be understood the ribs or webs 35 and 36 allow for the formation of a sturdy handle 47 that can be formed, e.g. molded, from a reduced amount of material, e.g., plastic.

The frozen confectionary holder of FIG. 11 includes a receptacle 42 that is configured to receive and hold a square frozen confectionary by a corner and in this regard is somewhat similar to the embodiment of the invention shown in FIG. 1. The side panels 45 and 46 of the receptacle of the embodiment of the invention shown in FIG. 11 cannot be seen because the size of panels 45 and 46 is limited to projecting limited to extending between the front and back panels 43 and 44 from the apex 37 to just above the out vertical ribs or webs 35. Small ribs or ridges 39 that protrude towards the inside of the receptacle 42 from the front and back panels 43 and 44 are shown in FIG. 11.

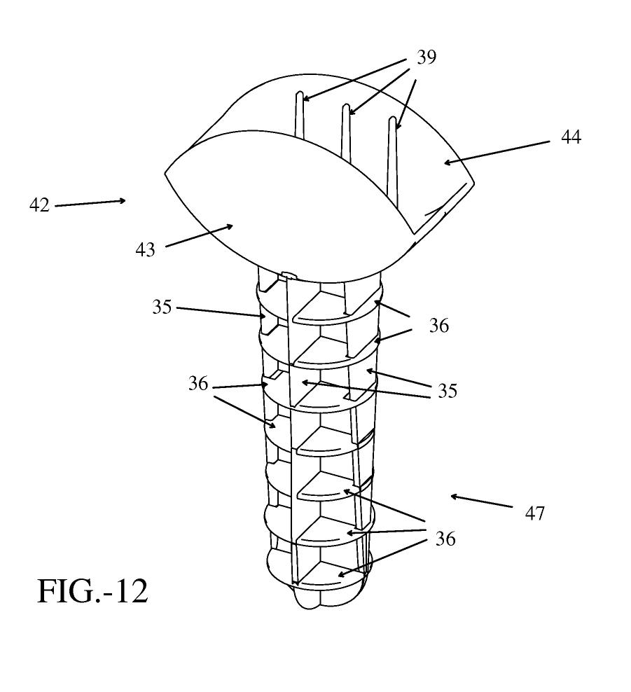

The frozen confectionary holder of FIG. 12 includes a receptacle 42 that is configured to receive and hold a circular frozen confectionary and in this regard is somewhat similar to the embodiment shown in FIG. 8. However, whereas the tops of the front and back panels 23 and 24 in FIG. 8 are linear, the tops of the front and back panels 43 and 44, in FIG. 12 are curved with the central portion being the higher point.

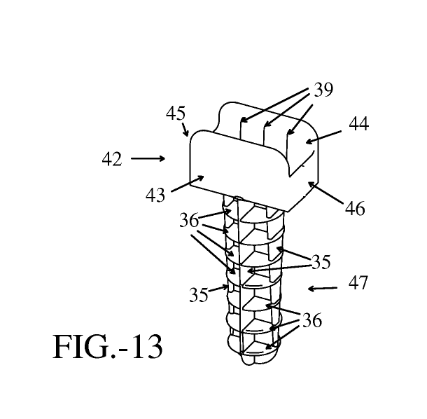

The frozen confectionary holder of FIG. 13 includes a receptacle 42 that is configured to receive and hold a rectangular frozen confectionary and in this regard is somewhat similar to the embodiment shown in FIGS. 6-7. However, whereas the opposed side panels 15 and 16 shown in FIGS. 6-7 are the same height as the front and back panels 13 and 14, in FIG. 13 the side panels 45 and 46 are shorter in height than the front and back panels 43 and 44.

While the basic shapes of the frozen confectionary holder of the present invention have been exemplified, it is within the scope of the present invention to provide frozen confectionary holders that have more prominent three-dimensional shapes such as children's action figures and characters or theme type shapes like cars, animals, etc.

In use one places a frozen (or non-frozen) confectionery into the receptacle of a frozen confectionery holder of the present invention after partially or fully unwrapping the frozen confectionary. As discussed above, the receptacle is configured and sized to allow access to a major portion of the frozen confectionery which the frozen confectionery is held in the receptacle and held by the handle. After the exposed portion of the frozen confectionery is eaten, the minor portion remaining in the receptacle can be removed with a utensil such as a small spoon, or otherwise accessed by a person's tongue. If desired, before use the frozen confectionery holder can be stored in a freezer or otherwise cooled to hasten the melting of a frozen confectioner held in the receptacle. The use of the frozen confectionery holder of the present invention does not involve pushing the frozen confectionery upwards in the receptacle as in the case of a “push-up” or the peeling away of the sides of the receptacle.

As noted above, while the holder of the present invention was initially designed and developed to hold frozen confectioneries, it is within the scope of the present invention to use the holder of the present invention to hold brownies, cakes, pastries and other non-frozen confectioneries as well as other types of foods. Thus reference herein to a “frozen confectionery holder” is not intended to limit the present invention to only holding frozen confectioneries.

Although the present invention has been described with reference to particular means, materials and embodiments, from the foregoing description, one skilled in the art can easily ascertain the essential characteristics of the present invention and various changes and modifications can be made to adapt the various uses and characteristics without departing from the spirit and scope of the present invention as described above and set forth in the attached claims.

1. A holder for confectioneries that have a geometric shape which holder includes:
a receptacle that is configured to receive a confectionery having a geometric shape, the receptacle having a shape that is complementary to the geometric shape of the confectionery and being configured to allow a major portion of the confectionery to be exposed when the confectionery is received in and supported by the receptacle; and
a handle coupled to a bottom portion of the receptacle to allow the holder to be hand held.

2. A holder for confectioneries according to claim 1, wherein the receptacle has a rectangular configuration.

3. A holder for confectioneries according to claim 1, wherein the receptacle has a corner shape with triangular shaped front and back panels and opposed rectangular side panels.

4. A holder for confectioneries according to claim 1, wherein the receptacle has a partial circular shape.

5. A holder for confectioneries according to claim 1, wherein the receptacle has a solid bottom.

6. A holder for confectioneries according to claim 1, wherein the bottom of the receptacle is free from any structure that projects upward into an interior space defined by the receptacle.

7. A holder for confectioneries according to claim 1, wherein the receptacle includes front and back walls that are provided with inwardly projecting ribs or ridges.

8. A confectionery in combination with the holder for confectioneries according to any one of claims 1-7.

9. The combination of claim 8, wherein the confectionery is a frozen confectionery.

10. The combination of claim 9, wherein the frozen confectionery comprises ice cream.

11. A method of eating a confectionery that has a geometric shape and which does not include a handle, the method comprising:
providing:
a confectionery having a geometric shape;
a receptacle having a shape that is complementary to the geometric shape of the confectionery and being configured to allow a major portion of the confectionery to be exposed when the confectionery is received in and supported by the receptacle; and
a handle coupled to a bottom portion of the receptacle to allow the holder to be hand held;
placing a portion of the confectionery into the receptacle so that a major portion of the confectionery is exposed; and
eating at least the exposed portion of the confectionery.

12. A method of eating a confectionery according to claim 11, wherein the receptacle has a rectangular configuration.

13. A method of eating a confectionery according to claim 11, wherein the receptacle has a corner shape with triangular shaped front and back panels and opposed rectangular side panels.

14. A method of eating a confectionery according to claim 11, wherein the receptacle has a partial circular shape.

15. A method of eating a confectionery according to claim 11, wherein the receptacle has a solid bottom.

16. A method of eating a confectionery according to claim 11, wherein the bottom of the receptacle is free from any structure that projects upward into an interior space defined by the receptacle.

17. A method of eating a confectionery according to claim 11, wherein the receptacle includes front and back walls that are provided with inwardly projecting ribs or ridges.

18. A method of eating a confectionery according to claim 11, wherein the confectionery is a frozen confectionery.

19. A method of eating a confectionery according to claim 11, wherein the frozen confectionery comprises ice cream.
